(19) United States
(12) Patent Application Publication
(10) Pub. No.: US 2025/0172745 A1
(43) Pub. Date: May 29, 2025

(54) MULTI-CORE OPTICAL FIBER

(71) Applicant: SUMITOMO ELECTRIC INDUSTRIES, LTD., Osaka-shi, Osaka (JP)

(72) Inventor: Tetsuya HAYASHI, Osaka-shi, Osaka (JP)

(21) Appl. No.: 18/725,402

(22) PCT Filed: Nov. 10, 2023
(86) PCT No.: PCT/JP2023/040553

§ 371 Date: Jun. 28, 2024

(30) Foreign Application Priority Data
Nov. 30, 2022 (JP) 2022-192004

(51) Int. Cl. G02B 6/02

(52) U.S. Cl. CPC G02B 6/02042

(57) ABSTRACT

A multi-core optical fiber includes four cores each extending along a center axis of the multi-core optical fiber, common cladding enclosing the four cores and having a lower refractive index than each of the four cores and coating resin enclosing the common cladding. The common cladding has a diameter of 124.5 μm to 125.5 μm. For each of the four cores, letting an effective area at a wavelength of 1550 nm be Aeff [μm²] and a cable cutoff wavelength be λcc [μm], Aeff satisfies Expression (1) and Expression (2) while λcc satisfies Expression (1) and Expression (3). The four cores are arranged such that Dc satisfies Expression (4) in relation to Aeff and λcc of each of the first core and the second core while OCT, Aeff, and λcc of the first core satisfy Expression (5).

### TECHNICAL FIELD

The present disclosure relates to a multi-core optical fiber. This application claims the priority of Japanese Patent Application No. 2022-192004, filed Nov. 30, 2022, the entirety of which is incorporated herein by reference.

### BACKGROUND ART

A step-index multi-core optical fiber (hereinafter abbreviated to MCF) including four cores and common cladding is disclosed in each of PTL 1 and NPL 1. Another MCF is disclosed in PTL 2 in which a first cladding region having a low refractive index is provided between each core and common cladding, whereby the crosstalk (hereinafter abbreviated to XT) between cores is reduced.

### CITATION LIST

### Patent Literature

PTL 1: Japanese Unexamined Patent Application Publication No. 2013-88458
PTL 2: Japanese Unexamined Patent Application Publication No. 2020-86054
PTL 3: Japanese Unexamined Patent Application Publication No. 2017-509171

### Non Patent Literature

NPL 1: T. Matsui et al., “STEP-INDEX PROFILE MULTI-CORE FIBRE WITH STANDARD 125 μM CLADDING TO FULL-BAND APPLICATION”, ECOC 2019, M. 1. D. 3
NPL. 2: Y. Sagae et al., “Ultra-Low-XT Multi-Core Fiber with Standard 125-μm Cladding for Long-Haul Transmission”, OECC 2019, TuC3-4
NPL 3: T. Hayashi et al., “Uncoupled Multi-core Fiber Design for Practical Bidirectional Optical Communications,” OFC, MIE. 1
NPL 4: R. J. Black and C. Pask, J. Opt. Soc. Am. A, JOSAA 1 (11), p. 1129-1131, 1984
NPL 5: Y. Kobayashi and T. Hayashi, “Behavior and measurement method of inter-core crosstalk in multicore fibers with core-dependent loss,” Opt. Express 31(1), pp. 502-508 (2023).

### SUMMARY OF INVENTION

An MCF according to the present disclosure includes four cores each extending along a center axis of the MCF, common cladding enclosing the four cores and having a lower refractive index than each of the four cores, and coating resin enclosing the common cladding. The common cladding has a diameter of 124.5 μm to 125.5 μm. For each of the four cores, letting an effective area at a wavelength of 1550 nm be Aeff [μm²] and a cable cutoff wavelength be λcc [μm], Aeff satisfies Expression (1) and Expression (2) while λcc satisfies Expression (1) and Expression (3):

$$Aeff \leq - 11.919 λ {cc}^{2} + 153.67 λ cc - 105.98 \qquad ( 1 )$$

$$70 \leq Aeff \leq 101.2 \qquad ( 2 )$$

$$1.27 \leq λ cc \leq 1.53 \qquad ( 3 )$$

In a cross section orthogonal to the center axis, letting a center-to-center distance between a first core that is one of the four cores and a second core that is located closest to the first core be Dc [μm], and a shortest distance between a center of the first core and an interface between the common cladding and the coating resin be OCT [μm], the four cores are arranged such that Dc satisfies Expression (4) in relation to Aeff and λcc of each of the first core and the second core, and such that OCT, Aeff, and λcc of the first core satisfy Expression (5):

$$Dc \geq 62.67 - 44.75 λ cc + 0.2217 Aeff + 9.911 λ {cc}^{2} - 8.461 \times {10}^{- 4} {Aeff}^{2} + 3.981 \times {10}^{- 2} λ ccAeff \qquad ( 4 )$$

$$OCT \geq 76.53 - 70.55 λ cc + 0.3821 Aeff + 19.56 λ {cc}^{2} - 6.48 \times {10}^{- 4} {Aeff}^{2} + 7.279 \times {10}^{- 2} λ ccAeff \qquad ( 5 )$$

### BRIEF DESCRIPTION OF DRAWINGS

FIG. 1 illustrates a cross section of an MCF according to an embodiment that is taken orthogonally to the center axis thereof.

FIG. 2 is a chart illustrating the relationship between the minimum value of adjacent-core pitch and effective area, the relationship making the XT in counter-propagation at the wavelength 1625 nm be 10⁻⁴/(100 km)² or less and being plotted for a plurality of cutoff frequencies.

FIG. 3 is a chart illustrating the relationship between the lower limit of outer cladding thickness and effective area, the relationship making the leakage loss at the wavelength 1625 nm be 0.001 dB/km or less and being plotted for a plurality of cutoff frequencies.

FIG. 4 is a chart illustrating the relationship between the lower limit of outer cladding thickness and effective area, the relationship making the leakage loss at the wavelength 1625 nm be 0.0005 dB/km or less and being plotted for a plurality of values of λcc.

FIG. 5 is a graph illustrating the relationship between the upper limit of effective area and cutoff frequency, the relationship being plotted for a plurality of cladding diameters and realizing a median design value for core pitch that makes the XT at the wavelength 1625 nm satisfy −40 dB/km or less and the leakage loss be 0.001 dB/km or less even if the core pitch varies by ±1 μm relative to the median design value.

FIG. 6 is a graph illustrating the relationship between the upper limit of effective area and cutoff frequency, the relationship being plotted for a plurality of cladding diameters and realizing a median design value for core pitch that makes the XT at the wavelength 1625 nm satisfy −40 dB/km or less and the leakage loss be 0.0005 dB/km or less even if the core pitch varies by ±1 μm relative to the median design value.

FIG. 7 illustrates a cross section of an MCF according to a first modification that is taken orthogonally to the center axis thereof.

FIG. 8 illustrates a cross section of an MCF according to a second modification that is taken orthogonally to the center axis thereof.

FIG. 9 illustrates refractive index profiles around the core that are applicable to the MCF according to the present disclosure.

FIG. 10 illustrates refractive index profiles around the core that are applicable to the MCF according to the present disclosure.

### DETAILED DESCRIPTION

### Problems to be Solved by Present Disclosure

According to NPL 2, the MCF disclosed in PTL 2 generates an increased loss in a range of 1580 nm or longer. In the known arts, the leakage loss at a wavelength of 1625 nm is not reduced satisfactorily. That is, the use of the L band (wavelengths from 1565 nm to 1625 nm) in long-distance transmission increases the transmission loss and therefore deteriorates the quality of signal transmission.

The present disclosure provides an MCF that can reduce a deterioration of signal-transmission quality in a wavelength range of 1530 nm to 1625 nm.

### Advantageous Effects of Present Disclosure

The MCF according to the present disclosure can reduce a deterioration of signal-transmission quality in a wavelength range of 1530 nm to 1625 nm.

### Description of Embodiments of Present Disclosure

First, embodiments of the present disclosure will be described in order.
(1) The MCF according to an embodiment of the present disclosure includes four cores each extending along a center axis of the MCF, common cladding enclosing the four cores and having a lower refractive index than each of the four cores, and coating resin enclosing the common cladding. The common cladding has a diameter of 124.5 μm to 125.5 μm. For each of the four cores, letting an effective area at a wavelength of 1550 nm be Aeff [μm²] and a cable cutoff wavelength be λcc [μm], Aeff satisfies Expression (1) and Expression (2) while λcc satisfies Expression (1) and Expression (3).

In a cross section orthogonal to the center axis, letting a center-to-center distance between a first core that is one of the four cores and a second core that is located closest to the first core be Dc [μm] and a shortest distance between a center of the first core and an interface between the common cladding and the coating resin be OCT [μm], the four cores are arranged such that Dc satisfies Expression (4) in relation to Aeff and λcc of each of the first core and the second core while OCT, Aeff, and λcc of the first core satisfy Expression (5).

$$Aeff \leq - 11.919 λ {cc}^{2} + 153.67 λ cc - 105.98 \qquad ( 1 )$$

$$70 \leq Aeff \leq 101.2 \qquad ( 2 )$$

$$1.27 \leq λ cc \leq 1.53 \qquad ( 3 )$$

$$Dc \geq 62.67 - 44.75 λ cc + 0.2217 Aeff + 9.911 λ {cc}^{2} - 8.461 \times {10}^{- 4} {Aeff}^{2} + 3.981 \times {10}^{- 2} λ ccAeff \qquad ( 4 )$$

$$OCT \geq 76.53 - 70.55 λ cc + 0.3821 Aeff + 19.56 λ {cc}^{2} - 6.48 \times {10}^{- 4} {Aeff}^{2} + 7.279 \times {10}^{- 2} λ ccAeff \qquad ( 5 )$$

In the above MCF, the XT in co-propagation between the first core and the second core at the wavelength 1625 nm is 10⁻⁴/km or less. Furthermore, the leakage loss at the wavelength 1625 nm is 0.001 dB/km or less. Such a configuration reduces a deterioration of signal-transmission quality at the wavelength 1625 nm. Employing the above MCF reduces the deterioration of signal-transmission quality in long-distance transmission with counter-propagation at least within a wavelength range of 1530 nm to 1625 nm.
(2) In embodiment (1) above, for each of the four cores, Aeff may satisfy Expression (6) while λcc may satisfy Expression (7):

$$70 \leq Aeff \leq 93. \qquad ( 6 )$$

$$1.27 \leq λ cc \leq 1.46 \qquad ( 7 )$$

Such a configuration reduces the deterioration of signal-transmission quality in long-distance transmission with counter-propagation at least within a wavelength range of 1460 nm to 1625 nm. That is, the deterioration of signal-transmission quality is reduced within a wavelength range of 1460 nm to 1625 nm or a wavelength range of 1530 nm to 1625 nm.
(3) In embodiment (1) or (2) above, for each of the four cores, λcc may satisfy Expression (8):

$$1.36 \leq λ c c \qquad ( 8 )$$

Such a configuration enhances the confinement to the cores and therefore further reduces the XT and the leakage loss.
(4) In any of embodiments (1) to (3) above, the four cores may be arranged such that the OCT, Aeff, and λcc of the first core satisfy Expression (9):

$$OCT \geq 78.9 - 72.75 λ c c + 0.3936 Aeff + 20.14 λ {cc}^{2} - 6.704 \times {10}^{- 4} {Aeff}^{2} + 7.480 \times 1 {0}^{- 2} λ ccAeff \qquad ( 9 )$$

In such a configuration, the leakage loss at the wavelength 1625 nm is 0.0005 dB/km or less.
(5) In any of embodiments (1) to (4) above, in the cross section, the four cores may have respective centers that are located one each at four vertices of a square each of whose sides has a length Dc. In such a configuration, since the four cores are arranged in symmetry, optical characteristics are evened out among the four cores.
(6) In any of embodiments (1) to (4) above, in the cross section, the four cores may have respective centers that are located one each at four vertices of an isosceles trapezoid three of whose sides each have a length Dc and one of whose sides is longer than Dc. In such a configuration, the cores are identifiable with no markers.
(7) In any of embodiments (1) to (6) above, the common cladding may be in contact with outer peripheral surfaces of the four cores. Such a configuration does not have a complicated refractive-index structure and is therefore manufacturable with increased ease.
(8) In embodiment (7) above, the four cores may each have a relative refractive index difference of 0.50% or less with reference to the refractive index of the common cladding. Such a configuration has neither deeply depressed cladding nor refractive index trench and is therefore manufacturable with increased ease. Furthermore, the refractive index difference between each of the cores and the common cladding is not excessively large. Thus, the transmission loss is reduced.
(9) The MCF according to any of embodiments (1) to (6) above may further include four individual claddings provided on an inner side of the common cladding and each enclosing a corresponding one of the four cores. Letting a relative refractive index difference of each of the four individual claddings with reference to the refractive index of the common cladding be Δic [%], Δic may satisfy Expression (10):

$$- 0.2 \leq Δ i c < 0 \qquad ( 10 )$$

Such a configuration has neither deeply depressed cladding nor refractive index trench and is therefore manufacturable with increased ease.
(10) The MCF according to any of embodiments (1) to (6) above may further include four individual claddings provided on an inner side of the common cladding and each enclosing a corresponding one of the four cores. Each of the cores that is located on an inner side of a corresponding one of the individual claddings may have a relative refractive index difference of 0.50% or less with reference to a refractive index of the corresponding individual cladding. Such a configuration has neither deeply depressed cladding nor refractive index trench and is therefore manufacturable with increased ease. Furthermore, the refractive index difference between each of the cores and the corresponding individual cladding is not excessively large. Thus, the transmission loss is reduced.

### DETAILS OF EMBODIMENTS OF PRESENT DISCLOSURE

Specific examples of the MCF according to the above embodiments will now be described with reference to the drawings as needed. The present disclosure is not limited to the following examples and is defined by the appended claims. It is intended that the present disclosure encompasses any changes equivalent to and within the scope of the claims. In the description of the drawings, like elements are denoted by like reference signs, and redundancy is omitted.

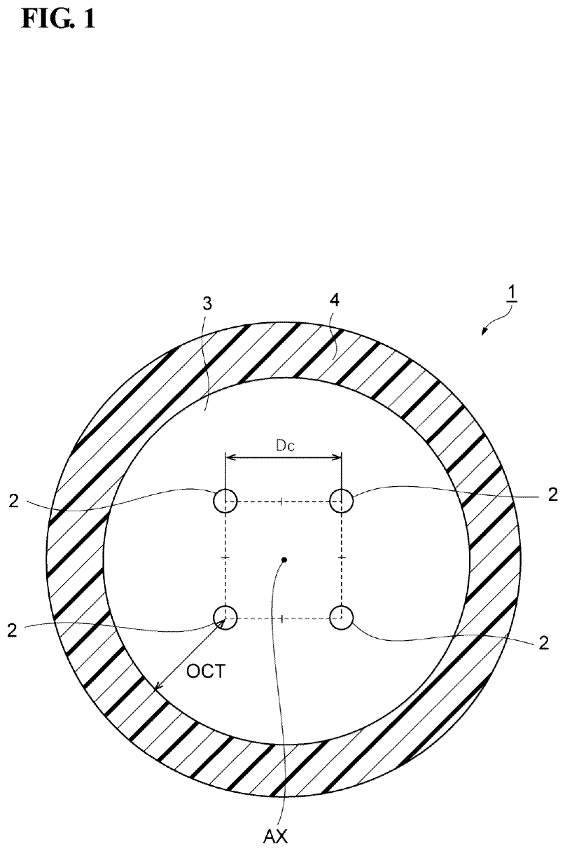

FIG. 1 illustrates a cross section of an MCF according to an embodiment that is taken orthogonally to the center axis thereof. As illustrated in FIG. 1, the MCF, 1, according to the embodiment is a four-core fiber including four cores 2, common cladding 3, and coating resin 4. The cores 2 are made of glass chiefly composed of silica. In the cross section orthogonal to the center axis, AX, the four cores 2 have the same circular shape. The four cores 2 each extend along the center axis AX of the MCF 1.

In the cross section orthogonal to the center axis AX, letting the center-to-center distance between a first core that is one of the four cores 2 and a second core that is located closest to the first core be Dc [μm], the value of Dc is constant regardless of which of the four cores 2 is the first core. That is, the four cores 2 have respective centers that are located one each at the four vertices of a square each of whose sides has a length Dc [μm]. The first core and the second core are adjacent cores, and Dc denotes the center-to-center distance between the adjacent cores. In the MCF 1, since the four cores 2 are arranged in symmetry, optical characteristics are homogenized among the four cores 2.

For each of the four cores 2, letting the effective area at a wavelength of 1550 nm be Aeff [μm²] and the cable cutoff wavelength be λcc [μm], Aeff satisfies Expression (1) and Expression (2) while λcc satisfies Expression (1) and Expression (3). The four cores 2 may have an equal Aeff or different Aeff's. Furthermore, the four cores 2 may have an equal λcc or different λcc's.

$$Aeff \leq - 11.919 λ c {c}^{2} + 153.67 λ cc - 105.98 \qquad ( 1 )$$

$$70 \leq Aeff \leq 101.2 \qquad ( 2 )$$

$$1.27 \leq λ cc \leq 1.530 \qquad ( 3 )$$

If Aeff is 70 μm² or greater, the deterioration of signal-transmission quality due to nonlinear interference is reduced. In Expression (1), to make Aeff be 70 μm² or greater, λcc needs to be 1270 nm or longer. If λcc is 1530 nm or shorter, single-mode behavior is realized at the C band (wavelengths from 1530 nm to 1565 nm) and the L band (wavelengths from 1565 nm to 1625 nm). Accordingly, an optical fiber suitable for optical signal transmission at the C band and the L band is realized. In Expression (1), to make λcc be 1530 nm or shorter, Aeff needs to be 101.2 μm² or smaller.

For each of the four cores 2, Aeff may satisfy Expression (6) while λcc may satisfy Expression (7). For each of the four cores 2, λcc may further satisfy Expression (8).

$$70 \leq Aeff \leq 93. \qquad ( 6 )$$

$$1.27 \leq λ cc \leq 1.4 \; 60 \qquad ( 7 )$$

$$1.36 \leq λ cc \qquad ( 8 )$$

In Expression (1), to make λcc be 1460 nm or shorter, Aeff needs to be 93.0 μm² or smaller.

The four cores 2 are arranged such that Dc satisfies Expression (4) in relation to the Aeff and λcc of each of the first core and the second core.

$$Dc \geq 62.67 - 44.75 λ cc + 0.2 \; 217 Aeff + 9.911 λ {cc}^{2} - 8.461 \times 1 {0}^{- 4} {Aeff}^{2} + 3.981 \times 1 {0}^{- 2} λ ccAeff \qquad ( 4 )$$

Thus, the XT in co-propagation between adjacent cores at the wavelength 1625 nm is reduced to 10⁻⁴/km or less. Accordingly, the XT in counter-propagation (counter XT) between adjacent cores at the wavelength 1625 nm is reduced to 10⁻⁴/(100 km)² or less. Such a configuration satisfactorily reduces the deterioration of signal quality due to the XT in counter-propagation. In co-propagation, the direction of optical-signal transmission is the same between adjacent cores. In counter-propagation, the direction of optical-signal transmission is different between adjacent cores.

In long-distance transmission with counter-propagation particularly, the span loss, or the transmission loss in the optical fiber between adjacent amplifying relays (in a span) is small. Therefore, according to NPL 3, what is dominant as a XT permissible in view of reducing the deterioration of signal quality is indirect XT, which is a XT generated between optical signals in co-propagation and through adjacent cores. Indirect XT is proportional to the square of the span length in each span and is therefore expressed herein in units of 1/(100 km)². Note that 10⁻⁴/(100 km)² is equal to 10⁻⁸/km². The cumulative value of indirect XTs over a plurality of spans is linear: a simple sum of the indirect XTs in the respective spans. Therefore, if the XT in counter-propagation is 10⁻⁴/(100 km)² or less, the counter XT in each span of a transmission system employing a counter-propagation multi-core optical fiber with an average span length of about 100 km or shorter is reduced to about 10⁻⁴/km or less. In the transmission system as a whole, the deterioration of signal quality due to XT is reduced regardless of the length of the optical fiber (or the number of spans). That is, noise due to XT is reduced more than noise due to an optical amplifier or noise due to nonlinear interference.

While the XT in co-propagation is allowed to increase up to such a level as to deteriorate the quality of optical-signal transmission, specifically to 10⁻⁴/km or less, the XT in counter-propagation is kept at or below such a level as to reduce the deterioration of the quality of optical-signal transmission. Such a configuration makes the below-described OCT realize a value that reduces leakage loss.

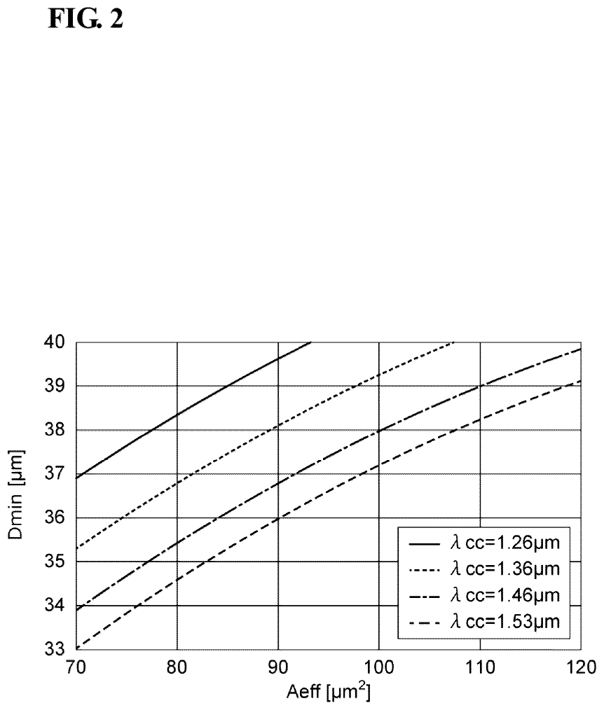

FIG. 2 is a chart illustrating the relationship between the lower limit of Dc (Dmin) and Aeff, the relationship making the XT in counter-propagation at the wavelength 1625 nm be 10⁻⁴/(100 km)² or less and being plotted for a plurality of values of λcc. The plurality of values of λcc are 1.26 μm, 1.36 μm, 1.46 μm, and 1.53 μm. In FIG. 2, the horizontal axis represents Aeff [μm²], and the vertical axis represents Dmin [μm]. For example, if λcc=1.53 μm, the relationship between Dmin and Aeff needs to be plotted above the lowest one of the curves in FIG. 2.

The relationships plotted in FIG. 2 are summarized in Expression (4). The chart illustrated in FIG. 2 was obtained by making a plurality of combinations of Aeff, λcc, and Dmin. Specifically, a plurality of combinations of Aeff and λcc were made by varying the radius, ra, of the cores 2 and the relative refractive index difference, Δ, of the cores. Then, Dmin was calculated for each of the combinations.

The common cladding 3 encloses the four cores 2. The common cladding 3 is in contact with the outer peripheral surfaces of the four cores 2. Between each of the cores 2 and the common cladding 3 is provided no depressed cladding. That is, the MCF 1 does not have a complicated refractive-index structure and is therefore manufacturable with increased ease.

The common cladding 3 is made of glass chiefly composed of silica. The common cladding 3 has a lower refractive index than each of the four cores 2. To produce a refractive index difference between each of the cores 2 and the common cladding 3, germanium (Ge) may be added to the cores 2. Alternatively, fluorine (F) may be added to the common cladding 3. The addition of a trace amount of F to the cores 2 and the common cladding 3 helps realize a depressed profile with increased ease of manufacture.

The relative refractive index difference, Δc, of each of the cores 2 is 0.50% or less with reference to the refractive index of any cladding that is in contact with the core 2. In the present embodiment, the common cladding 3 is in contact with each of the cores 2. Therefore, the cladding taken as the reference for refractive index is the common cladding 3. The relative refractive index difference Δc of each of the cores 2 with reference to the refractive index of the common cladding 3 is denoted by Δ1. Specifically, the relative refractive index difference Δ1 of each of the four cores 2 with reference to the refractive index of the common cladding 3 is 0.50% or less. The MCF 1 has neither deeply depressed cladding nor refractive index trench and is therefore manufacturable with increased ease. The refractive index difference produced between each of the cores 2 and the common cladding 3 is not excessively large. Thus, the transmission loss is reduced.

The common cladding 3 has a diameter (cladding diameter) of 124.5 μm to 125.5 μm. The common cladding 3 has a diameter (2rb) that is the same as the cladding diameter of a general-purpose single-mode optical fiber that is widely spread. Therefore, the common cladding 3 is as handleable and mechanically reliable as the cladding of the general-purpose optical fiber.

The coating resin 4 encloses the common cladding 3. The coating resin 4 is in contact with the outer peripheral surface of the common cladding 3. The coating resin 4 is, for example, ultraviolet-curable resin.

The four cores 2 are arranged such that, in a cross section orthogonal to the center axis AX, letting the shortest distance between the center of the first core and the interface between the common cladding 3 and the coating resin 4 be OCT (outer cladding thickness) [μm], the OCT, Aeff, and λcc of the first core satisfy Expression (5).

$$OCT \geq 76.53 - 70.55 λ cc + 0.3 \; 821 Aeff + 19.56 λ {cc}^{2} - 6.48 \times {10}^{- 4} {Aeff}^{2} + 7.279 \times 1 {0}^{- 2} λ ccAeff \qquad ( 5 )$$

Thus, the leakage loss at the wavelength 1625 nm is reduced to 0.001 dB/km or less.

The four cores 2 may alternatively be arranged such that the OCT, Aeff, and λcc of the first core satisfy Expression (9).

$$OCT \geq 76.9 - 72.75 λ cc + 0.3936 Aeff + 20.14 λ {cc}^{2} - 6.704 \times {10}^{- 4} {Aeff}^{2} + 7.480 \times 1 {0}^{- 2} λ ccAeff \qquad ( 9 )$$

Thus, the leakage loss at the wavelength 1625 nm is reduced to 0.0005 dB/km or less.

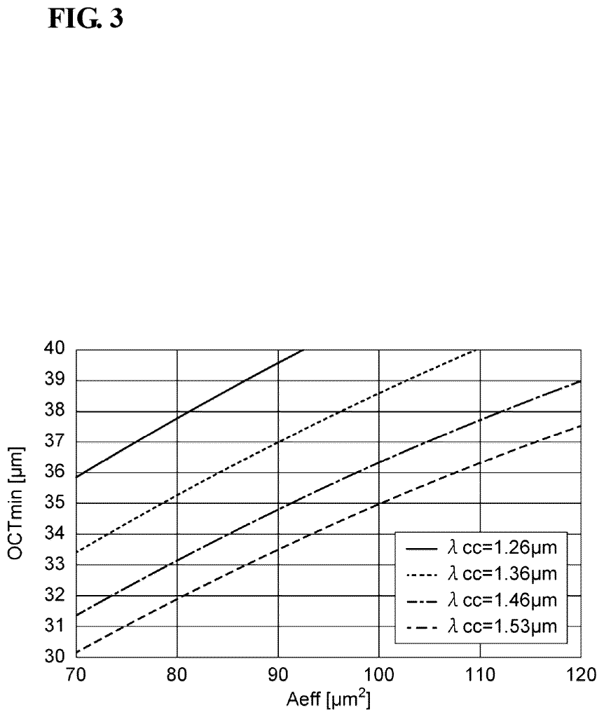

FIG. 3 is a chart illustrating the relationship between the lower limit of OCT (OCTmin) and Aeff, the relationship making the leakage loss at the wavelength 1625 nm be 0.001 dB/km or less and being plotted for a plurality of values of λcc. The plurality of values of λcc are 1.26 μm, 1.36 μm, 1.46 μm, and 1.53 μm. In FIG. 3, the horizontal axis represents Aeff [μm²], and the vertical axis represents OCTmin [μm]. For example, if λcc=1.53 μm, the relationship between OCTmin and Aeff needs to be plotted above the lowest one of the curves in FIG. 3.

The relationships plotted in FIG. 3 are summarized in Expression (5). The chart illustrated in FIG. 3 was obtained by making a plurality of combinations of Aeff, λcc, and OCTmin. Specifically, a plurality of combinations of Aeff and λcc were made by varying the radius ra of the cores 2 and the relative refractive index difference Δ1 of the cores 2 with reference to the refractive index of the common cladding 3. Then, OCTmin was calculated for each of the combinations.

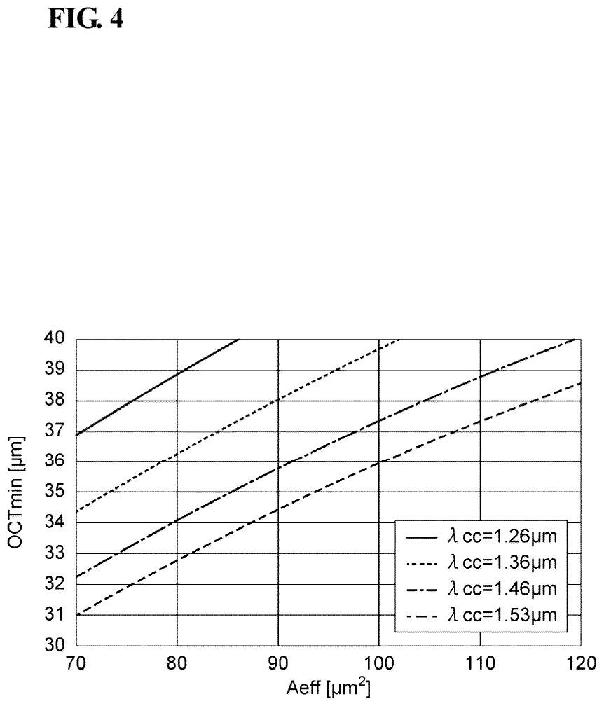

FIG. 4 is a chart illustrating the relationship between the lower limit of OCT (OCTmin) and Aeff, the relationship making the leakage loss at the wavelength 1625 nm be 0.0005 dB/km or less and being plotted for a plurality of values of λcc. The plurality of values of λcc are 1.26 μm, 1.36 μm, 1.46 μm, and 1.53 μm. In FIG. 4, the horizontal axis represents Aeff [μm²], and the vertical axis represents OCTmin [μm]. For example, if λcc=1.53 μm, the relationship between OCTmin and Aeff needs to be plotted above the lowest one of the curves in FIG. 4.

The relationships plotted in FIG. 4 are summarized in Expression (9). The chart illustrated in FIG. 4 was obtained by making a plurality of combinations of Aeff, λcc, and OCTmin. Specifically, a plurality of combinations of Aeff and λcc were made by varying the radius ra of the cores 2 and the relative refractive index difference Δ of the cores. Then, OCTmin was calculated for each of the combinations.

The diameter of the common cladding 3 is 124.5 μm or greater and 125.5 μm. Therefore, the leakage loss becomes largest if the diameter of the common cladding 3 is 124.5 μm. With the diameter of the common cladding 3 being 124.5 μm, the core pitch (Dc) may vary by #1 μm relative to the median design value. Nevertheless, in a certain relationship between Aeff and λcc, there exists a median design value for Dc that makes the counter XT at the wavelength 1625 nm satisfy 10⁻⁴/(100 km)² and the leakage loss be 0.001 dB/km or less. Such a relationship is represented by Expression (1). That is, as long as the relationship between Aeff and λcc satisfies Expression (1), even if the core pitch (Dc) varies by ±1 μm relative to the median design value with the diameter of the common cladding 3 being 124.5 μm to 125.5 μm, there exists a median design value for Dc that makes the counter XT at the wavelength 1625 nm satisfy 10⁻⁴/(100 km)² and the leakage loss be 0.001 dB/km or less.

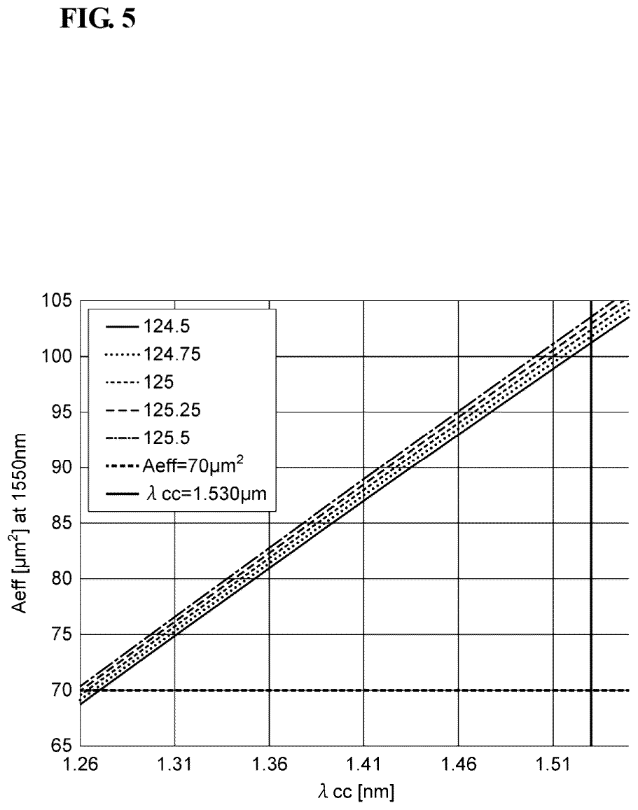

FIG. 5 is a graph illustrating the relationship between the upper limit of Aeff and λcc, the relationship being plotted for a plurality of cladding diameters and making the counter XT at the wavelength 1625 nm satisfy 10⁻⁴/(100 km)² or less and the leakage loss be 0.001 dB/km or less even if the core pitch varies by ±1 μm relative to the median design value. The plurality of cladding diameters were set within a range of 124.5 μm to 125.5 μm. The plurality of cladding diameters are 124.5 μm, 124.75 μm, 125 μm, 125.25 μm, and 125.5 μm. In FIG. 5, the horizontal axis represents λcc [μm], and the vertical axis represents the upper limit of Aeff. In FIG. 5, the innermost one of the substantially triangular areas defined by the curves and the straight lines corresponds to the area where Expression (1), Expression (2), and Expression (3) are satisfied.

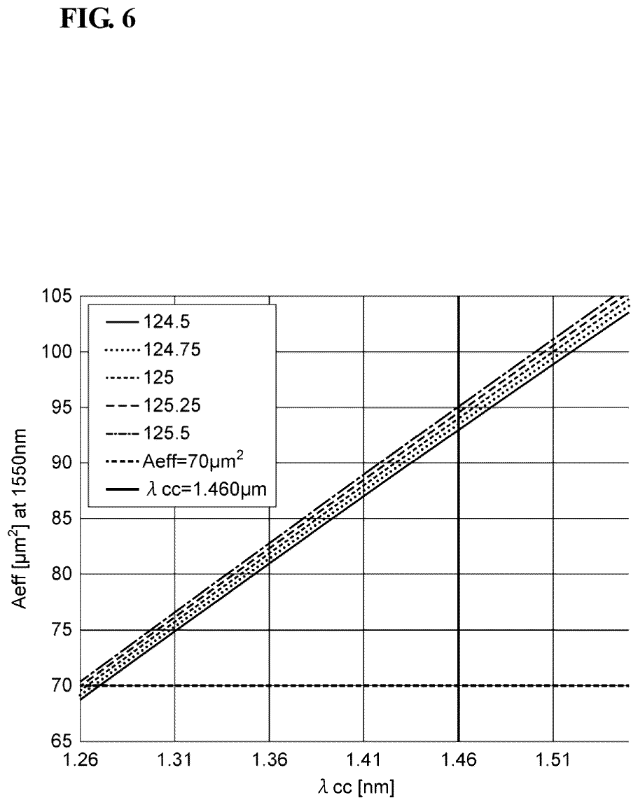

FIG. 6 is a graph illustrating the relationship between the upper limit of Aeff and λcc, the relationship being plotted for a plurality of cladding diameters within the range of 124.5 μm to 125.5 μm and making the counter XT at the wavelength 1625 nm satisfy 10⁻⁴/(100 km)² and the leakage loss be 0.0005 dB/km or less even if the core pitch varies by ±1 μm relative to the median design value. In FIG. 6, the horizontal axis represents λcc [μm], and the vertical axis represents the upper limit of Aeff. In FIG. 6, the innermost one of the substantially triangular areas defined by curves and straight lines corresponds to the area where Expression (1), Expression (6), and Expression (7) are satisfied.

If Expression (1), Expression (2), and Expression (3) are satisfied and if Expression (5) is further satisfied, the bending loss generated by bending with a radius of 25 mm or greater is well below 0.1 dB per 100 turns. Therefore, even if an excess portion of the MCF 1 is wound with a radius of 25 mm or greater to be stored in a relay or a station facility, the increase in the loss is reduced.

To summarize, in the MCF 1 according to the present embodiment, the XT in co-propagation between adjacent cores at the wavelength 1625 nm is 10⁻⁴/km or less. Furthermore, the leakage loss at the wavelength 1625 nm is 0.001 dB/km or less. Such a configuration reduces the deterioration of signal-transmission quality at the wavelength 1625 nm. Employing the MCF 1 reduces the deterioration of signal-transmission quality in long-distance transmission with counter-propagation at least within a wavelength range of 1530 nm to 1625 nm.

While an embodiment has been described above, the present disclosure is not limited to the above embodiment. Various changes can be made to the present disclosure without departing from the essence of the present disclosure.

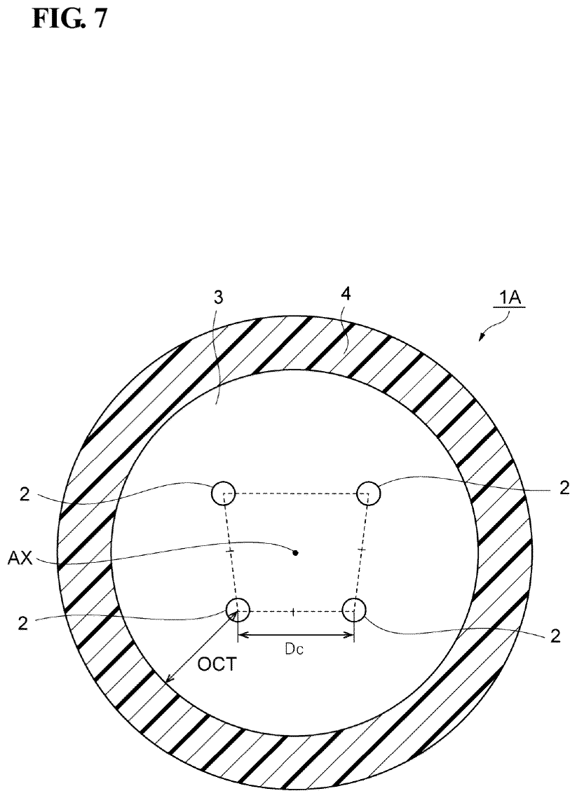

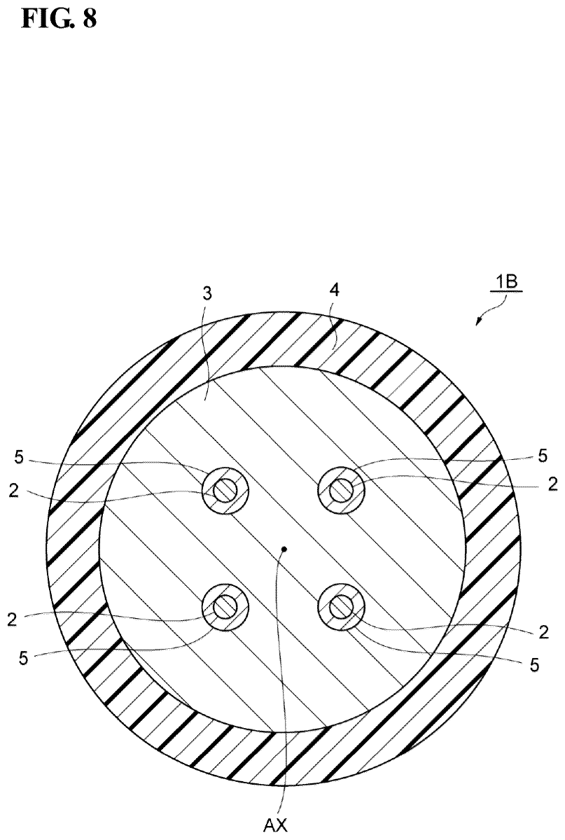

FIG. 7 illustrates a cross section of an MCF according to a first modification that is taken orthogonally to the center axis thereof. As illustrated in FIG. 8, in the cross section of the MCF, 1A, according to the first modification that is taken orthogonally to the center axis AX, the four cores 2 have respective centers that are located one each at the four vertices of an isosceles trapezoid three of whose sides each have a length Dc and one of whose sides is longer than Dc. In the MCF 1A, the cores 2 are identifiable with no markers.

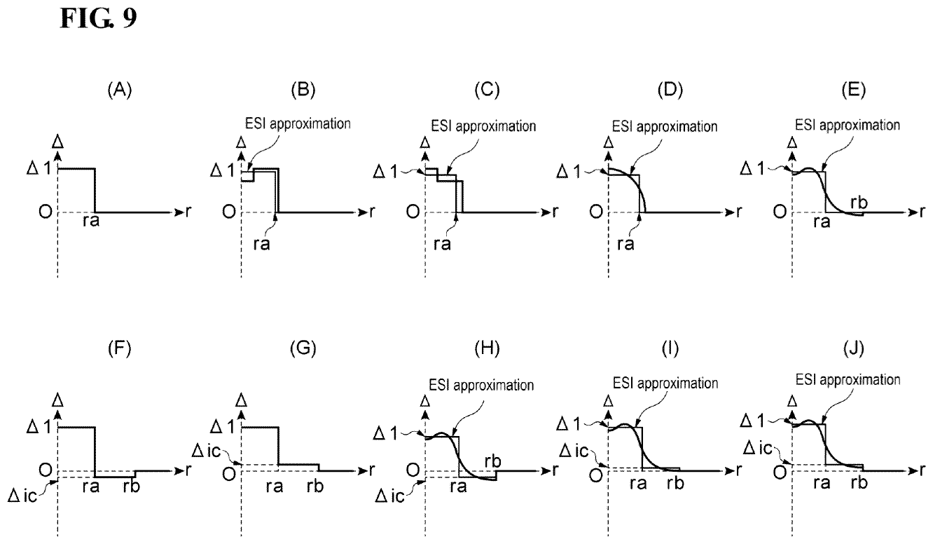

FIG. 8 illustrates a cross section of an MCF according to a second modification that is taken orthogonally to the center axis thereof. As illustrated in FIG. 9, the MCF, 1B, according to the second modification further includes four individual claddings 5. The four individual claddings 5 are provided on the inner side of the common cladding 3 and each enclose a corresponding one of the four cores 2. Letting the relative refractive index difference of each of the four individual claddings 5 with reference to the refractive index of the common cladding 3 be Δic [%], Δic satisfies Expression (10).

$$- 0.20 \leq Δ i c < 0 \qquad ( 10 )$$

As described above, the relative refractive index difference Δc of each of the cores 2 is 0.50% or less with reference to the refractive index of any cladding that is in contact with the core 2. In the present modification, the cladding taken as the reference for refractive index is a corresponding one of the individual claddings 5, that is, the individual cladding 5 that encloses the core 2 of interest. The MCF 1B has neither deeply depressed cladding nor refractive index trench and is therefore manufacturable with increased ease. The refractive index difference produced between each of the cores 2 and the corresponding individual cladding 5 is not excessively large. Thus, the transmission loss is reduced.

FIG. 9 illustrates refractive index profiles around the core that are applicable to the MCF according to the present disclosure. Regarding the core structure of the MCF according to the present disclosure, the refractive index profile of the core and relevant optical characteristics are selectable from appropriate ones in view of the purpose of use. For example, pattern (A) to pattern (J) illustrated in FIG. 9 are applicable refractive index profiles. In FIG. 9, A denotes the relative refractive index difference with reference to the refractive index of the common cladding, and r denotes the radius vector (radius) with reference to each core center, which are represented in a local coordinate system in which the core center and a Δ of 0% are defined at the origin, O. The structure may be the same or different between different cores.

Referring to FIG. 9, pattern (A) represents a stepped refractive index profile, pattern (B) represents a ring refractive index profile, pattern (C) represents a double-stepped refractive index profile, pattern (D) represents a graded refractive index profile, and pattern (E) represents a drooping-hem refractive index profile. These patterns are applicable to the core structure of the MCF according to the present disclosure. Furthermore, pattern (F) and pattern (H) each include a depressed refractive index profile around the core; pattern (G), pattern (I), and pattern (J) each include a raised refractive index profile around the core; and pattern (E) includes a matched refractive index profile around the core. These patterns are also applicable to the core structure.

Pattern (A), pattern (B), pattern (C), and pattern (D) are for the MCF 1 according to the embodiment and for the MCF 1A according to the first modification. Pattern (F) and pattern (H), if satisfying Expression (10), are for the MCF 1B according to the second modification.

If ESI (equivalent-step-index) approximation is applied to those refractive index profiles other than the stepped refractive index profile represented by pattern (A), the radius ra and the relative refractive index difference Δ1 of the core that are approximated by the stepped profile are obtained (NPL 4). NPL 4 is easily applicable if the interface between the core and the cladding is clear. Refractive index profiles represented by pattern (E), pattern (H), pattern (I), and pattern (J), in each of which the interface between the core and the common cladding is unclear, may each be put to ESI approximation by regarding r that makes the smallest dA/dr (the steepest inclination toward the lower right) in the pre-ESI-approximation refractive index profile as the pre-approximation radius of the core. The relative refractive index difference (Δic) of the individual cladding may be the average of pre-approximation relative refractive index differences of the cores in respective areas regarded as the individual claddings. Specifically, the average may be taken at the middle point between ra and rb on the horizontal axis (r axis): (rb−ra)/3+ra≤r≤2 (rb−ra)/3+ra.

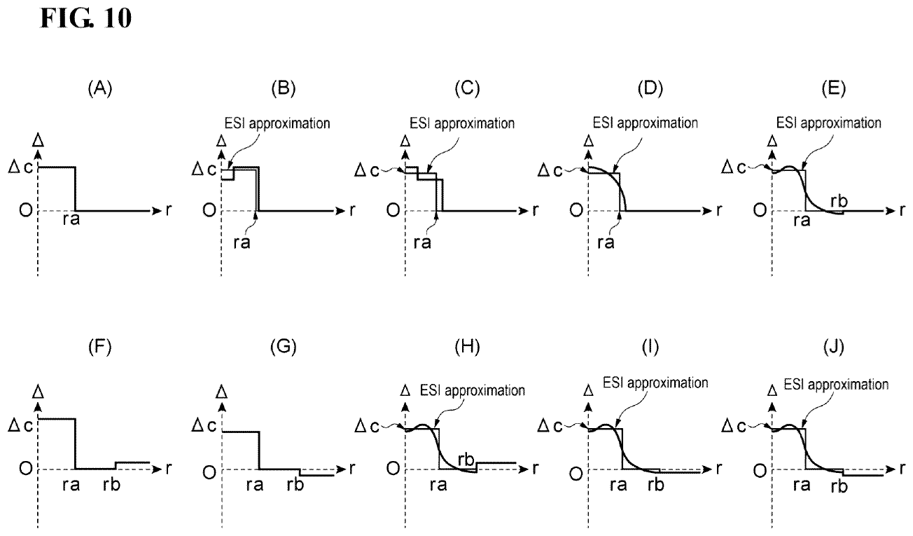

FIG. 10 illustrates refractive index profiles around the core that are applicable to the MCF according to the present disclosure. While Δ in FIG. 9 is the relative refractive index difference with reference to the refractive index of the common cladding, Δ in FIG. 10 is the relative refractive index difference with reference to the refractive index of any cladding that is in contact with the core. Hence, in FIG. 10, the relative refractive index difference of the core is denoted by Δc. Patterns (A) to (E) illustrated in FIG. 10 are based on a configuration in which the common cladding is taken as the reference for refractive index, and therefore represent substantially the same refractive index profiles represented by patterns (A) to (E) in FIG. 9. Patterns (F) to (J) illustrated in FIG. 10 are based on a configuration in which any cladding other than the common cladding is in contact with the core, and therefore represent refractive index profiles that are different from those represented by patterns (F) to (J) illustrated in FIG. 9.

The refractive index profile around the core is not limited to the refractive index profiles represented by patterns (A) to (J) illustrated in FIGS. 9 and 10.

The feature quantities and characteristics of the MCF according to the present disclosure are measurable as follows. The refractive indices of the cores, the common cladding, and the individual claddings are measurable by using, for example, a refraction near-field technique or horizontal interferometry. The diameter of the common cladding is measurable by using, for example, a refraction near-field technique, horizontal interferometry, or a cross-sectional image of the MCF that is observed through a microscope (a transmission near-field technique). The effective area Aeff is measurable by using, for example, a technique described in Appendix III of ITU-T G. 650.2 (08/2015). The cable cutoff wavelength λcc is measurable by using, for example, a technique described in Chapter 6.3 of ITU-T G. 650.1 (10/2020). The center-to-center distance Dc between the first core and the second core located closest to the first core is measurable by using, for example, a refraction near-field technique, horizontal interferometry, or a cross-sectional image of the MCF that is observed through a microscope (a transmission near-field technique). The shortest distance OCT between the center of the first core and the interface between the common cladding and the coating resin is measurable by using, for example, a refraction near-field technique, horizontal interferometry, or a cross-sectional image of the MCF that is observed through a microscope (a transmission near-field technique). The XT in co-propagation is measurable by using a technique described in NPL 5. The XT in counter-propagation is estimatable from the XT in co-propagation and on the basis of an expression described in NPL 3. The leakage loss is measurable by using a technique disclosed in PTL 3. The components of the multi-core fiber are measurable by performing fluorescence X-ray analysis.

While the above expressions are provided with no units, the units of the constants and coefficients in Expressions (1) to (10) are as follows. Note that [-] stands for dimensionless quantity.

$$- 11.919 [ - ] , 153.67 [ μm ] , - 105.98 [ μ {m}^{2} ] \qquad Equation ( 1 )$$

$$70 [ {μm}^{2} ] , 101.2 [ μ {m}^{2} ] \qquad Equation ( 2 )$$

$$1.27 [ μm ] , 1.53 [ μm ] \qquad Equation ( 3 )$$

$$62.67 [ μm ] , - 44. 75 [ - ] , 0.2217 [ {μm}^{- 1} ] , 9.911 [ {μm}^{- 1} ] , - 8.461 \times 1 {0}^{- 4} [ {μm}^{- 3} ] , 3.981 \times 1 {0}^{- 2} [ {μm}^{- 2} ] \qquad Equation ( 4 )$$

$$76.53 [ μm ] , - 70. 55 [ - ] , 0.3821 [ {μm}^{- 1} ] , 19.56 [ {μm}^{- 1} ] , - 6.48 \times 1 {0}^{- 4} [ {μm}^{- 3} ] , 7.279 \times 1 {0}^{- 2} [ {μm}^{- 2} ] \qquad Equation ( 5 )$$

$$70 [ {μm}^{2} ] , 93. [ {μm}^{2} ] \qquad Equation ( 6 )$$

$$1.27 [ μm ] , 1.46 [ μm ] \qquad Equation ( 7 )$$

$$1.36 [ μm ] \qquad Equation ( 8 )$$

$$78.9 [ μm ] , - 72. 75 [ - ] , 0.3936 [ {μm}^{- 1} ] , 20.14 [ {μm}^{- 1} ] , - 6.704 \times 1 {0}^{- 4} [ {μm}^{- 3} ] , 7.48 \times 1 {0}^{- 2} [ {μm}^{- 2} ] \qquad Equation ( 9 )$$

$$- 0.2 [ \% ] , 0 [ \% ] \qquad Equation ( 10 )$$

Symbols representing the above physical quantities and the like are regarded as including no units and are regarded as representing values in the units added to the respective symbols. Expressions (1) to (10) hold true even if regarded as dimensionless. In that case, the values of λcc used in relevant expressions are in units of [μm]. In the above description, some of the values of λcc are in units of [nm], for comparison with the wavelengths of optical signals.

### REFERENCE SIGNS LIST

1, 1A, 1B MCF
2 core
3 common cladding
4 coating resin
5 individual cladding
AX center axis
Dc center-to-center distance between adjacent cores
OCT outer cladding thickness
Δ relative refractive index difference
Δc relative refractive index difference of core with reference to cladding that is in contact with core
Δ1 relative refractive index difference of core with reference to refractive index of common cladding
Δic relative refractive index difference of individual cladding
ra radius of core
rb radius of cladding

What is claimed is:

1. A multi-core optical fiber comprising:
four cores each extending along a center axis of the multi-core optical fiber;
common cladding enclosing the four cores and having a lower refractive index than each of the four cores; and
coating resin enclosing the common cladding,
wherein the common cladding has a diameter of 124.5 μm to 125.5 μm,
wherein, for each of the four cores, letting an effective area at a wavelength of 1550 nm be Aeff [μm²] and a cable cutoff wavelength be λcc [μm], Aeff satisfies Expression (1) and Expression (2) while λcc satisfies Expression (1) and Expression (3), and
wherein, in a cross section orthogonal to the center axis, letting a center-to-center distance between a first core that is one of the four cores and a second core that is located closest to the first core be Dc [μm] and a shortest distance between a center of the first core and an interface between the common cladding and the coating resin be OCT [μm], the four cores are arranged such that Dc satisfies Expression (4) in relation to Aeff and λcc of each of the first core and the second core while OCT, Aeff, and λcc of the first core satisfy Expression (5):
$$Aeff \leq - 11.9 \; 19 λ {cc}^{2} + 153.67 λ cc - 105 \text{.98} \qquad ( 1 )$$
$$70 \leq Aeff \leq 10 \; 1.2 \qquad ( 2 )$$
$$1.27 \leq λ cc \leq 1.530 \qquad ( 3 )$$
$$Dc \geq 62.67 - 44.75 λ cc + 0.2 \; 217 Aeff + 9. 9 \; 11 λ {cc}^{2} - 8.461 \times 1 {0}^{- 4} {Aeff}^{2} + 3.981 \times 1 {0}^{- 2} λ ccAeff \qquad ( 4 )$$
$$OCT \geq 76.53 - 70.55 λ cc + 0.3 \; 821 Aeff + 19.56 λ {cc}^{2} - 6.48 \times 1 {0}^{- 4} {Aeff}^{2} + 7.279 \times 1 {0}^{- 2} λ ccAeff \qquad ( 5 )$$

2. The multi-core optical fiber according to claim 1,
wherein, for each of the four cores, Aeff satisfies Expression (6) while λcc satisfies Expression (7):
$$70 \leq Aeff \leq 93. \qquad ( 6 )$$
$$1.27 \leq λ cc \leq 1.460 \qquad ( 7 )$$

3. The multi-core optical fiber according to claim 1,
wherein, for each of the four cores, λcc satisfies Expression (8):
$$1.36 \leq λ c c \qquad ( 8 )$$

4. The multi-core optical fiber according to claim 1,
wherein the four cores are arranged such that the OCT, Aeff, and λcc of the first core satisfy Expression (9):
$$OCT \geq 78.9 - 72.75 λ cc + 0.3936 Aeff + 20.14 λ {cc}^{2} - 6.704 \times {10}^{- 4} {Aeff}^{2} + 7.480 \times 1 {0}^{- 2} λ ccAeff \qquad ( 9 )$$

5. The multi-core optical fiber according to claim 1,
wherein, in the cross section, the four cores have respective centers that are located one each at four vertices of a square each of whose sides has a length Dc.

6. The multi-core optical fiber according to claim 1,
wherein, in the cross section, the four cores have respective centers that are located one each at four vertices of an isosceles trapezoid three of whose sides each have a length Dc and one of whose sides is longer than Dc.

7. The multi-core optical fiber according to claim 1,
wherein the common cladding is in contact with outer peripheral surfaces of the four cores.

8. The multi-core optical fiber according to claim 7,
wherein the four cores each have a relative refractive index difference of 0.50% or less with reference to the refractive index of the common cladding.

9. The multi-core optical fiber according to claim 1, further comprising:
four individual claddings provided on an inner side of the common cladding and each enclosing a corresponding one of the four cores,
wherein, letting a relative refractive index difference of each of the four individual claddings with reference to the refractive index of the common cladding be Δic [%], Δic satisfies Expression (10):
$$- 0.20 \leq Δ i c < 0 \qquad ( 10 )$$

10. The multi-core optical fiber according to claim 1, further comprising:
four individual claddings provided on an inner side of the common cladding and each enclosing a corresponding one of the four cores,
wherein each of the cores that is located on an inner side of a corresponding one of the individual claddings has a relative refractive index difference of 0.50% or less with reference to a refractive index of the corresponding individual cladding.
